(19) United States
(12) Patent Application Publication
(10) Pub. No.: US 2002/0067683 A1
(43) Pub. Date: Jun. 6, 2002

(54) Temperature sensitive patterned media transducers

(75) Inventors: Paul R. Iverson, St. Croix Falls, WI (US); Michael B. Hintz, Mahtomedi, MN (US); Joseph H. Sexton, Oakdale, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 09/730,103

(22) Filed: Dec. 5, 2000

(51) Int. Cl. G11B 9/00

(52) U.S. Cl. 369/126

(57) ABSTRACT

Playback transducers for patterned media systems comprise temperature sensitive resistors, including thermistors and resistance temperature detectors. The transducers are typically thin film depositions mounted on a slider for flying head application. Possible configurations are generally V-shaped, may involve parallel or perpendicular recording geometry, and are conceptually similar to (but simpler in construction than) magnetoresistive or giantmagnetoresistive thin film transducers. The transducers may incorporate supplementary heating elements and/or coatings to optimize performance.

### FIELD OF THE INVENTION

This invention concerns temperature sensitive playback transducers for data storage systems in which data is recorded in patterned media.

### BACKGROUND OF THE INVENTION

To meet the insatiable demand for inexpensive and inexhaustible data storage, the long and steady march of progress in the field of data recording and electronic playback has relied on many technical approaches. No approach has outperformed the versatility and extremely high storage densities of magnetic recording, in which a signal is recorded by selectively varying the magnetic moments of physical regions of media such as flexible tapes or rigid (typically rotating) disks. Another broad class of approaches relies on variations in the physical shape of the surface of the media. Such features are not detected directly, but rather are used to cause corresponding variations in characteristics such as reflectivity, coercivity, and the like that may be detected accordingly (e.g., an optical detection system, in the case of variations in reflectivity).

### SUMMARY OF THE INVENTION

The invention involves non-magnetic transducers for patterned media systems. More specifically, such transducers comprise a temperature sensitive resistor and a bias current path including the temperature sensitive resistor. The temperature sensitive resistor may comprise a thermistor, for example, a thermistor comprising a material selected from the group consisting essentially of Co₂O₃, MN₂O₃, NiO, and boron-doped diamond-like carbon. Other embodiments of the temperature sensitive resistor comprise a resistance temperature detector, for example a resistance temperature detector comprising a material selected from the group consisting essentially of nickel and platinum. Other embodiments of the transducer are thin film structures. The transducer and the leads may be of the same material but this is not required. The transducer may be generally V-shaped but this is not required. The transducer may further comprise a heating element in close proximity to the temperature sensitive resistor. It may also further comprise a coating layer. A transducer of the invention defines a film plane, and the bias current path may lie parallel or perpendicular to the film plane.

### BRIEF DESCRIPTION OF THE DRAWINGS

The accompanying drawings show a particular embodiment of the invention as an example, and do not limit the scope of the invention.

FIG. 1 is schematic view of a patterned media system.

FIG. 2 is a schematic view of the transducer of FIG. 1.

FIGS. 3-7 are schematic views of other embodiments of the invention.

### DETAILED DESCRIPTION

In general terms, the invention includes various embodiments of data playback transducers that utilize temperature sensitive resistors to create signals representative of patterns of physical features present in the surfaces of patterned media. Thus, the recorded data (typically in a known format or pattern) is represented in some manner in variations in the physical features on the patterned medium. A transducer of the invention “senses” (or otherwise reacts to) these variations to produce a signal that represents the data recorded on the medium. The transducer is connected in any convenient manner (usually an electrical or electronic connection) to appropriate circuitry that can process the transducer signal as required. These connections and circuitry are not part of the invention.

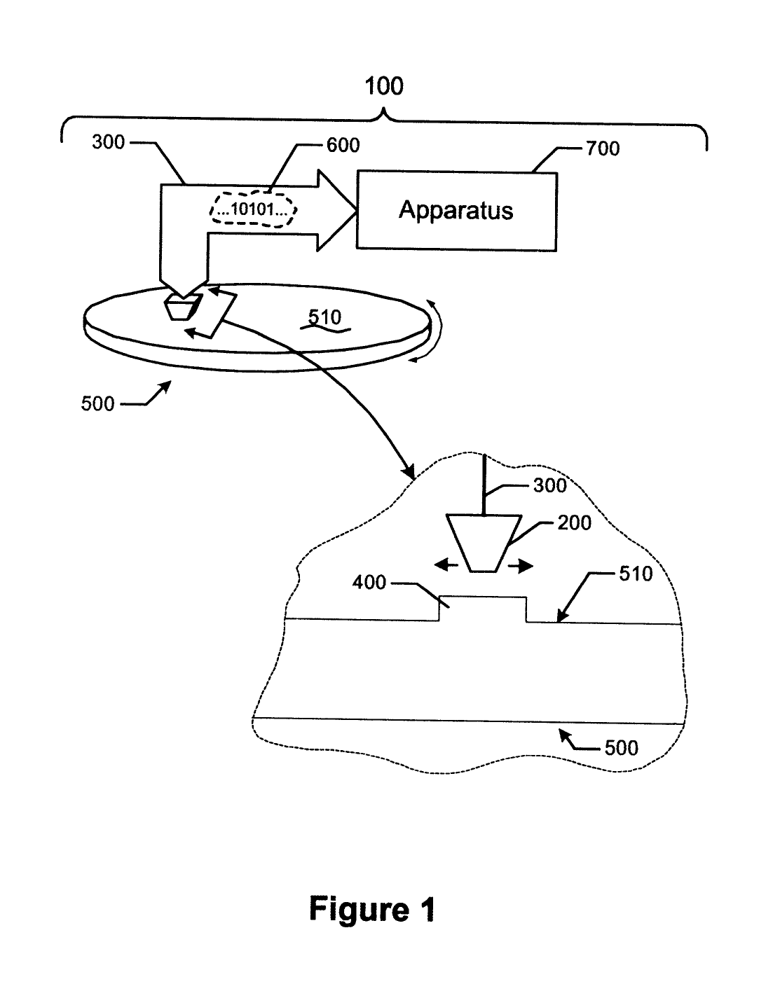

FIG. 1 is a general schematic diagram of a data storage system 100. In general terms, the invention includes various embodiments of a non-magnetic playback transducer 200 that utilizes temperature sensitive resistors to create a signal 300 representative of topographical features 400 present in the surface 510 of a patterned medium 500. Thus, the data 600 has been recorded, or represented in a known format or patter, in variations in the physical features 400 on the patterned medium 500. Transducer 200 senses physical features 400 and produces a signal 300 that represents the data 600 recorded on the patterned medium 500. The transducer 200 is connected in any convenient manner (usually an electrical or electronic connection) to appropriate circuitry 700 that can process the transducer signal 300 as required.

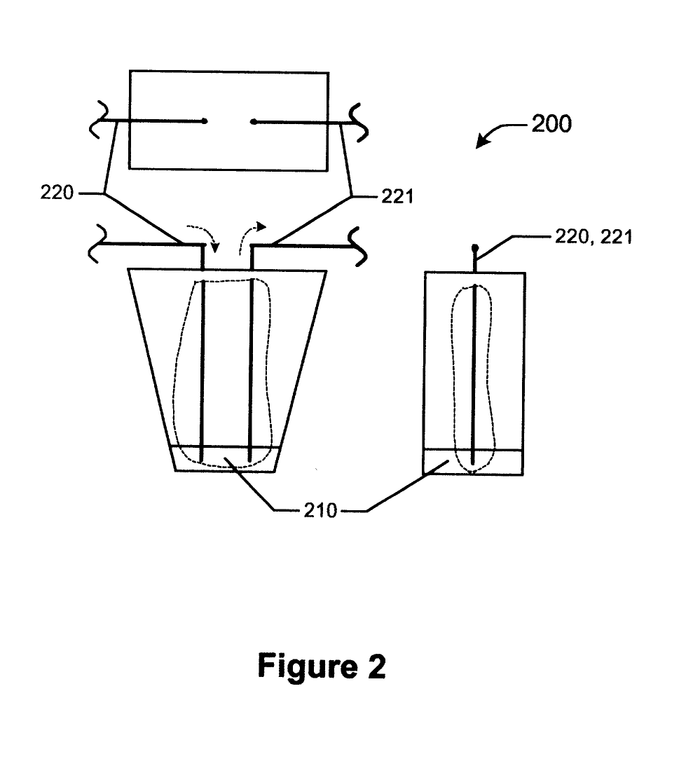

FIG. 2 shows top, front, and side schematic views of one embodiment of the invention. Transducer 200 comprises a temperature sensitive resistor (TSR) 210, i.e., an element that varies in electrical resistivity as a function of its temperature. One broad class of TSR included in the scope of this embodiment is known as a thermistor, and another broad class of TSR included in the scope of this embodiment is known as a resistance temperature detector (RTD). Thermisters and RTDs utilize the temperature dependence of resistivity of semiconductors and metals, respectively.

In either case, a bias current is placed through the device (as indicated by the dashed line and arrows) on leads 220 and 221. The change in electrical potential (voltage) through the TSR due to the resistivity of the material is measured by connecting leads 220, 221 to appropriate circuitry 700 (see FIG. 1). All other factors being equal (or appropriately taken into account), measured changes in the resistivity are due to actual changes in the temperature experienced by the TSR, such as those changes created by exposing it to the variations in features 400 of patterned medium 500 (see FIG. 1).

Any materials that produce the required temperature varying resistivity are suitable. Possible thermistor materials include Co₂O₃, MN₂O₃, and NiO. Another possible material is a boron-doped diamond-like carbon (DLC) material, or B-DLC, which is suitable in some applications because of its very high sensitivity, high thermal conductivity, and low specific heat; these properties are associated with faster response times than other materials. Possible RTD materials include nickel and platinum.

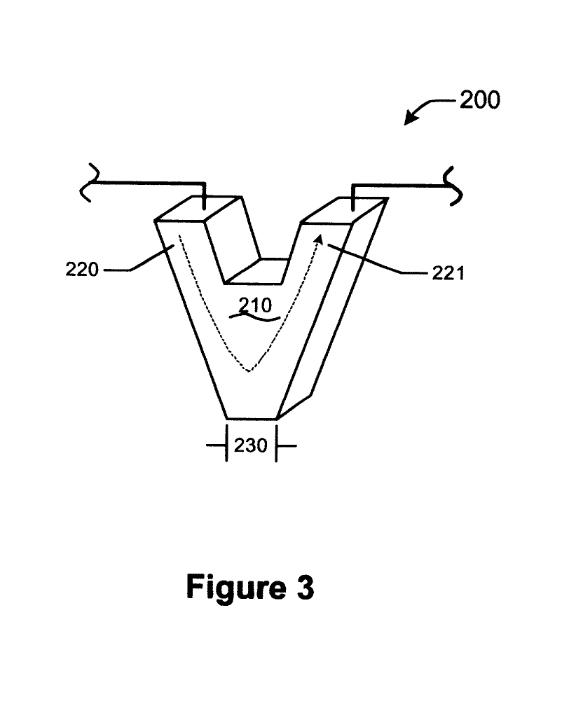

FIG. 3 is a schematic representation of a specific embodiment of a RID transducer 200. In general terms, this embodiment can be envisioned as a thin film structure in which the resistor 210 and the current carrying leads 220, 221 are the same material. A single-step process, such as a single deposition using conventional deposition equipment, is one possible (but not required) manufacturing technique permitted by use of a single material. In the context of this process, transducer 200 defines a so-called “film plane” that is parallel to the front view of the device. The design of FIG. 3 also is relatively simple in shape and therefore involves fewer and simpler lithographic steps in its manufacturing process, even if more than a single step is involved.

In general terms, transducer 200 comprises an element portion 210 that presents a recording surface 230 that is sometime called a “gap” or “detection region” by analogy to the space between opposite polarity magnetic poles used in conventional magnetic data recording. However, in the transducers of this invention, no open space is required. The transducer 200 is mounted in a conventional manner on a slider or other platform (which is not shown for clarity). Transducer 200 is mounted so that recording surface 230 is generally parallel to the surface 510 of the patterned medium 500. As indicated by dashed lines, the bias current flows to and from the recording surface 230 through each of a pair of leads 220, 221 that are arranged to direct the current flow generally perpendicular to the surface 510.

The shape of transducer 200 is schematic only and should not be considered a limitation on the scope of the invention. Nonetheless, it can be said that in the embodiment shown, transducer 200 is generally V-shaped in overall appearance, with the playback element 210 residing between the arms 220, 221 that form the leads of transducer 200. The size and shape of playback element 210 defines detection region 230. A detection region 230 of approximately 0.3 micrometer would be suitable for a transducer 200 manufactured from nickel but this is only an example and not a limitation on the scope of the invention.

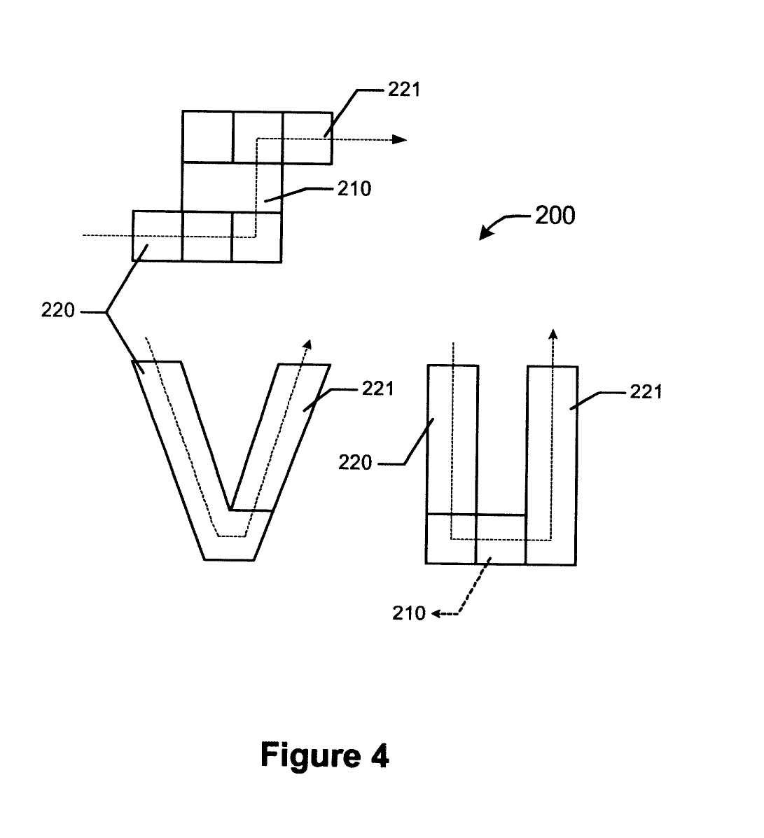

In the case of a thermistor-based transducer 200, the resistivity of the material typically chosen would typically be many orders of magnitude greater than that of RTD materials. Therefore, as illustrated in FIG. 4, it would be possible to pass the current through transducer 200 perpendicular to the thin film plane, as indicated by the dashed line. This produces a transducer 200 that is thicker in the perpendicular direction, but otherwise transducer 200 is somewhat V-shaped in the parallel direction, similar to the embodiment of FIG. 3. As before, transducer 200 generally comprises an element portion 220 that presents a detection region 230 parallel to the surface 510 of patterned medium 500. Current flows to and from the detection region through each of a pair of leads 220, 221 that are arranged to present the current flow direction generally perpendicular to the recording surface. As before, transducer 200 is generally V-shaped in overall appearance, with the playback element portion 210 residing between the arms of the transducer 200 and defining the detection region 230.

Again a detection region of approximately 0.3 micrometer would be suitable for a transducer 200 manufactured from a material such as B-DLC, but this is only an example and not a limitation on the scope of the invention. To achieve this value, it is possible to use a B-DLC element 210 that is doped in a conventional manner to a resistivity of 10³ ohm-cm, has a thickness of approximately 10 nanometers, and lateral (detection region) dimensions of 0.3 micrometer by 2 micrometers. This would produce an element 210 having a resistance of approximately 170×10³ ohm, a value that would significantly limit current flow through transducer 200, even for bias potentials on the order of 10 volts. However, B-DLC has been shown to be suitable for TCRs in excess of 100% per Celsius degree, which may provide a signal sufficient to compensate for the higher noise such voltage levels would produce at low currents.

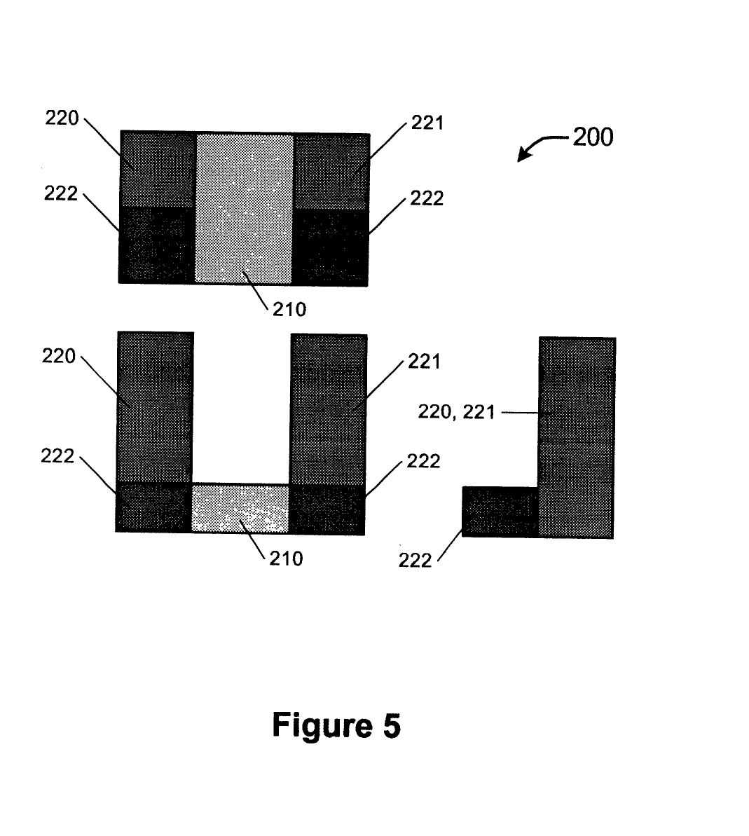

FIG. 5 is a schematic representation of a specific embodiment of a RID transducer 200 within the scope of the invention. In general terms, this embodiment can be envisioned as a conventional magnetoresistive (MR) or giant magnetoresistive (GMR) transducer in which the MR element used to read data has been replaced by a stripe 210 of RID material. However, the design of conventional MR and GMR read elements are heavily constrained by the need for permanent magnets 222, bias fields, and appropriately designed current leads 220, 221 in close proximity to the actual field sensing material 210. Thus, the transducer of FIG. 5 may be appropriate in some circumstances because it presumably could be manufactured relatively easily by using only a simple modification of a manufacturing process that is currently used in high volumes. However, the transducer of FIG. 5 would not be possible in many circumstances because it includes features that are not required once the constraint of a MR or GMR element is removed.

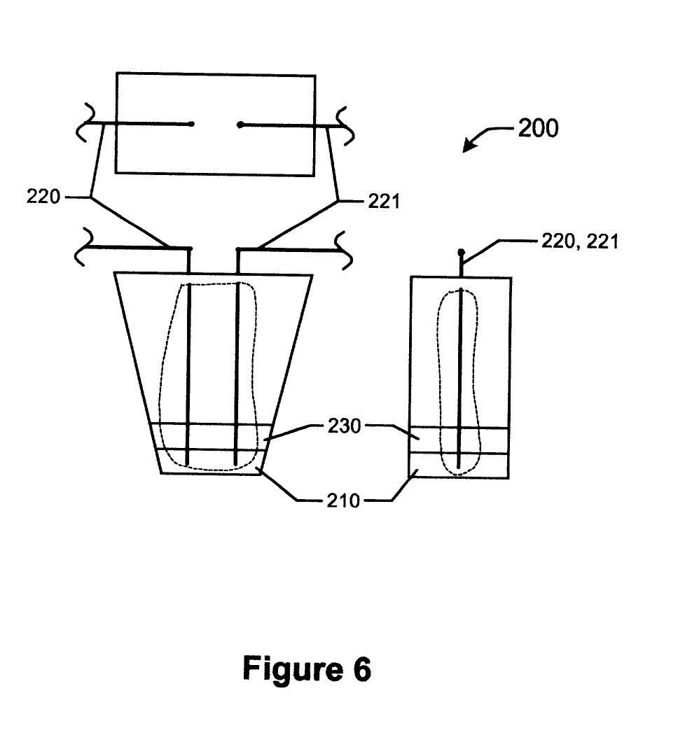

In each of the embodiments described above, an optional additional feature includes actively heating the transducer element to place it within an optimal operating tempera range. In non-heated embodiments, some Joule heating of the biased temperature sensitive resistor itself will heat the transducer by an amount that may be significant depending on the parameters and materials chosen. But it may be desirable to generate additional heat to achieve a larger temperature differential between the transducer and the patterned medium surface. As illustrated schematically in FIG. 6, one technique for actively heating the transducer element is to add a heating element 230 in close proximity to the temperature sensitive resistor 210. Heating element 230 adds additional complexity to the transducer construction, but would still involve relatively simple materials to implement. Energy would be provided to heating element 230 in a conventional manner (not shown for clarity) that is not critical to the scope of the invention.

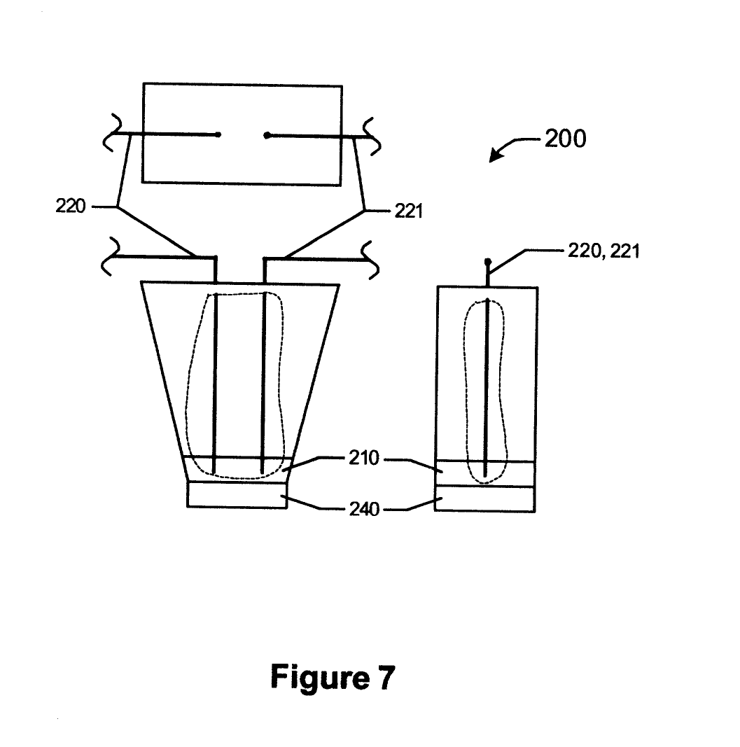

As illustrated schematically in FIG. 7, an optional additional feature includes a protective coating layer 240 on the bottom of transducer 200. This mechanically robust feature also provides high thermal conductivity between the patterned medium and the resistor element 210. A suitable material for coating layer 240 is diamond-like carbon (DLC) but the invention is not limited to this material. Also, coating layer 240 may be added to any of the embodiments of the invention described above.

In each of the embodiment described above, references to particular elements (e.g., nickel and platinum) should be understood to include not only pure elements but also alloys that include such elements, according to principles known in the art of electromagnetic structures.

What is claimed is:

1. A non-magnetic transducer for a data playback system, comprising:
a) a temperature sensitive resistor; and
b) a bias current path including the temperature sensitive resistor.

2. The transducer of claim 1, in which the temperature sensitive resistor comprises a thermistor.

3. The transducer of claim 2, in which the thermistor comprises a material selected from the group consisting essentially of Co₂O₃, MN₂O₃, NiO, and boron-doped diamond-like carbon.

4. The transducer of claim 1, in which the temperature sensitive resistor comprises a resistance temperature detector.

5. The transducer of claim 4, in which the resistance temperature detector comprises a material selected from the group consisting essentially of nickel and platinum.

6. The transducer of claim 1, in which the transducer is a thin film structure.

7. The transducer of claim 1, in which the transducer and the leads are the same material.

8. The transducer of claim 1, in which the transducer is generally V-shaped.

9. The transducer of claim 1, further comprising a heating element in close proximity to the temperature sensitive resistor.

10. The transducer of claim 1, further comprising a protective coating layer on the bottom of the transducer.

11. The transducer of claim 1, in which the transducer defines a film plane, and the bias current path lies parallel to the film plane.

12. The transducer of claim 1, in which the transducer defines a film plane, and the bias current path lies perpendicular to the film plane
